(19) United States
(12) Patent Application Publication
(10) Pub. No.: US 2021/0009148 A1
(43) Pub. Date: Jan. 14, 2021

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Chihiro Oguro, Wako-shi (JP); Katsuya Yashiro, Wako-shi (JP); Ayumu Horiba, Wako-shi (JP); Tadahiko Kanoh, Wako-shi (JP)

(21) Appl. No.: 16/924,248

(22) Filed: Jul. 9, 2020

(30) Foreign Application Priority Data
Jul. 10, 2019 (JP) 2019-128404

(51) Int. Cl. B60W 50/08; B60W 50/14; B60W 30/14

(52) U.S. Cl. CPC B60W 50/082; B60W 2554/406; B60W 30/146; B60W 50/14

(57) ABSTRACT

A vehicle control device includes a recognizer configured to recognize a surrounding situation of a vehicle and a driving controller configured to control a speed or steering of the vehicle based on a recognition result of the recognizer. The driving controller selects one of a plurality of traveling states in which rates of automation related to control of the vehicle are different from each other. The driving controller switches the selected traveling state to the traveling state different from the traveling state selected among the plurality of traveling states when a continuous traveling time or a continuous traveling distance that the vehicle continuously travels in the selected traveling state exceeds a standard value.

### CROSS-REFERENCE TO RELATED APPLICATION

Priority is claimed on Japanese Patent Application No. 2019-128404, filed Jul. 10, 2019, the content of which is incorporated herein by reference.

### BACKGROUND

### Field of the Invention

The present invention relates to a vehicle control device, a vehicle control method, and a storage medium.

### Description of Related Art

In the related art, a navigation device for an automated driving vehicle selecting a route of an own vehicle traveling through automated driving is disclosed (for example, see Japanese Unexamined Patent Application, First Publication No. 2017-26562). The navigation device selects a route along which an own vehicle travels based on the degree of continuation of automated driving along a retrieved route based on a position of the own vehicle and a set destination.

### SUMMARY

In the technology of the foregoing related art, however, continuing or stopping a predetermined driving state in the automated driving has not been considered.

The present invention is devised in view of such circumstances and an objective of the present invention is to provide a vehicle control device, a vehicle control method, and a storage medium capable of performing automated driving in a driving state that is appropriate for an execution situation of the automated driving.

A vehicle control device, a vehicle control method, and a storage medium according to the present invention adopt the following configurations.

(1) According to an aspect of the present invention, a vehicle control device includes: a recognizer configured to recognize a surrounding situation of a vehicle; and a driving controller configured to control a speed or steering of the vehicle based on a recognition result of the recognizer. The driving controller may select one of a plurality of traveling states in which rates of automation related to control of the vehicle are different from each other. The driving controller may switch the selected traveling state to the traveling state different from the traveling state selected among the plurality of traveling states when a continuous traveling time or a continuous traveling distance that the vehicle continuously travels in the selected traveling state exceeds a standard value.

(2) In the vehicle control device according to the aspect (1), the plurality of traveling states may be a first traveling state and a second traveling state in which the rate of automation is lower than in the first traveling state.

(3) In the vehicle control device according to the aspect (2), in the first traveling state, one or both of a task related to monitoring of surroundings of the vehicle and a task related to a steering wheel of the vehicle may not be imposed on an occupant of the vehicle.

(4) In the vehicle control device according to the aspect (2) or (3), the driving controller may switch the traveling state to the second traveling state when a continuous traveling time of the first traveling state has passed for a predetermined time or a continuous traveling distance of the first traveling state has passed with a predetermined distance.

(5) In the vehicle control device according to the aspect (2) or (4), a first control state may be a control state executed when the vehicle is performing following travel of following a front vehicle of the vehicle.

(6) In the vehicle control device according to any one of the aspects (1) to (5), the driving controller may set the standard value so that the continuous traveling time or the continuous traveling distance easily exceeds the standard value based on one or both of information regarding movement of the vehicle and information regarding a state of a driver of the vehicle.

(7) In the vehicle control device according to the aspect (6), the driving controller may set the standard value based on at least the information regarding the state of the driver of the vehicle. The information regarding the state of the driver may be alertness of the driver. The standard value may be set so that the continuous traveling time or the continuous traveling distance exceeds the standard value more easily as the alertness of the driver is lower.

(8) In the vehicle control device according to the aspect (6) or (7), the driving controller may set the standard value based on at least the information regarding the state of the driver of the vehicle. The information regarding the state of the driver may be a posture of the driver. The standard value may be set so that the continuous traveling time or the continuous traveling distance exceeds the standard value more easily as the degree of displacement of the posture of the driver with respect to a standard posture is higher.

(9) In the vehicle control device according to any one of the aspects (1) to (8), the driving controller may set the standard value based on at least information regarding movement of the vehicle. The information regarding the movement of the vehicle may be a remaining time until the vehicle arrives at a destination. The standard value may be set based on a remaining time until the vehicle arrives at the destination.

(10) In the vehicle control device according to any one of the aspects (1) to (9), the driving controller may set the standard value based on at least information regarding movement of the vehicle. The information regarding the movement of the vehicle may be a speed of the vehicle. The standard value may be set based on the speed of the vehicle.

(11) In the vehicle control device according to any one of the aspects (1) to (10), the driving controller may slow a speed of the vehicle or inhibits an increase in the speed of the vehicle when the selected traveling state is switched to the different traveling state.

(12) The vehicle control device according to any one of the aspects (1) to (11) may further include an output controller configured to cause an output device to output one or both of a notification for requesting a driver of the vehicle to monitor surroundings of the vehicle and a notification for requesting the driver of the vehicle to grasp a steering wheel when the driving controller switches the selected traveling state to the different traveling state.

(13) The vehicle control device according to any one of the aspects (1) to (12) may further include an output controller configured to give a notification encouraging the driver of the vehicle to take a break when the selected traveling state is continuously executed for a first time or the vehicle has traveled more than a first distance in the selected traveling state, and give a notification encouraging the driver of the vehicle to take a break when the different traveling state is continuously executed for a second time shorter than the first time or the vehicle has traveled more than a second distance shorter than the first distance in the different traveling state.

(14) In the vehicle control device according to any one of the aspects (1) to (13), the selected control state may be a control state executed when the vehicle is performing following travel of following a front vehicle of the vehicle. When the front vehicle is is no longer present during the following travel of following the front vehicle of the vehicle, the driving controller may switch the selected control state to the different control state even before the continuous traveling time has passed a set time.

(15) In the vehicle control device according to any one of the aspects (1) to (14), the selected control state may be a control state executed when the vehicle is performing following travel of following a front vehicle of the vehicle. The vehicle control device may further comprise an output controller configured to cause an output device to output one or both of a notification for requesting a driver of the vehicle to monitor surroundings of the vehicle and a notification for requesting the driver of the vehicle to grasp a steering wheel when the front vehicle is no longer present during the following travel of following the front vehicle of the vehicle.

(16) According to another aspect of the present invention, a vehicle control method is provided causing a computer to perform: recognizing a surrounding situation of a vehicle; controlling a speed or steering of the vehicle based on a recognition result; selecting one of a plurality of traveling states in which rates of automation related to control of the vehicle are different from each other; and switching the selected traveling state to the traveling state different from the traveling state selected among the plurality of traveling states when a continuous traveling time or a continuous traveling distance that the vehicle continuously travels in the selected traveling state exceeds a standard value.

(17) According to another aspect of the present invention, a non-transitory computer-readable storage medium is provided that stores a computer program to be executed by a computer to perform at least: recognizing a surrounding situation of a vehicle; controlling a speed or steering of the vehicle based on a recognition result; selecting one of a plurality of traveling states in which rates of automation related to control of the vehicle are different from each other; and switching the selected traveling state to the traveling state different from the traveling state selected among the plurality of traveling states when a continuous traveling time or a continuous traveling distance that the vehicle continuously travels in the selected traveling state exceeds a standard value.

According to the aspect (1) to (17), it is possible to perform the automated driving in a driving state that is appropriate for an execution situation of the automated driving.

According to the aspect (11), switching the control state is realized in a state suitable for a driver.

### BRIEF DESCRIPTION OF THE DRAWINGS

FIG. 1 is a diagram showing a configuration of a vehicle system in which a vehicle control device according to a first embodiment is used.

FIG. 2 is a diagram showing a functional configuration of a first controller and a second controller.

FIG. 3 is a flowchart showing an example of a flow of a process performed by an automated driving control device.

FIG. 4 is a diagram showing an example of a change in a speed of a vehicle after step S106.

FIG. 5 is a flowchart showing an example of a flow of a process performed by a driver and an occupant monitor.

FIG. 6 is a diagram showing an example of content of an information table.

FIG. 7 is a flowchart showing an example of a flow of a process performed by the automated driving control device after transition to a driving state C.

FIG. 8 is a diagram showing an example of predetermined control.

FIG. 9 is a flowchart showing an example of a flow of a process performed by an automated driving control device according to a second embodiment.

FIG. 10 is a diagram showing an example of a state of a driver which does not satisfy a second condition.

FIG. 11 is a diagram showing an example of a state of the driver which does not satisfy the second condition.

FIG. 12 is a diagram showing a process in which a set time is changed based on a remaining time.

FIG. 13 is a diagram showing an example of a hardware configuration of the automated driving control device according to an embodiment.

### DETAILED DESCRIPTION

Hereinafter, an embodiment of a vehicle control device, a vehicle control method, and a storage medium according to the present invention will be described with reference to the drawings.

### First Embodiment

### [Overall Configuration]

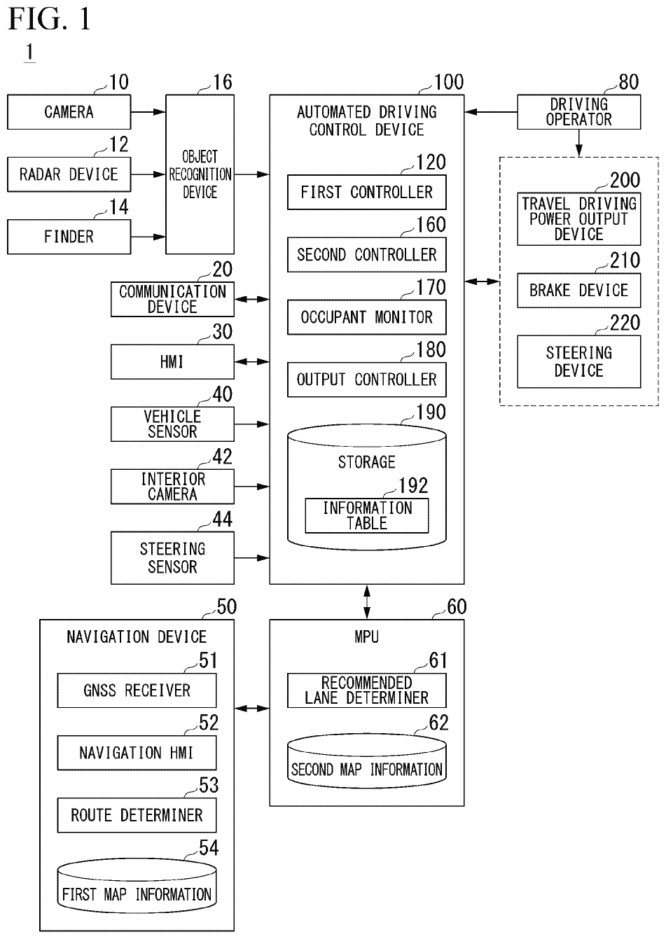

FIG. 1 is a diagram showing a configuration of a vehicle system 1 in which a vehicle control device according to a first embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, an interior camera 42, a steering sensor 44, a navigation device 50, a map positioning unit (MPU) 60, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle system 1 is mounted (hereinafter referred to as a vehicle M). When the camera 10 images a front side, the camera 10 is mounted on an upper portion of a front windshield, a rear surface of a rearview mirror, or the like. When the camera 10 images a rear side, the camera 10 is mounted on an upper portion of a rear windshield or the like. For example, the camera 10 repeatedly images the surroundings of the vehicle M periodically. The camera 10 may be a stereo camera.

The radar device 12 radiates radio waves such as millimeter waves to the surroundings of the vehicle M and detects radio waves (reflected waves) reflected from an object to detect at least a position (a distance from and an azimuth of) of the object. The radar device 12 is mounted on any portion of the vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the vehicle M and measures scattered light. The finder 14 detects a distance to a target based on a time from light emission to light reception. The radiated light is, for example, pulsed laser light. The finder 14 is mounted on any portions of the vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with another vehicle around the own vehicle M using, for example, a cellular network, a Wi-Fi network, Bluetooth (registered trademark), dedicated short range communication (DSRC) or the like or communicates with various server devices via radio base stations.

The HMI 30 presents various types of information to occupants of the vehicle M and receives input operations by the occupants. The HMI 30 includes various display devices, speakers, buzzers, touch panels, switches, and keys.

The vehicle sensor 40 includes a vehicle speed sensor that detects a speed of the vehicle M, an acceleration sensor that detects acceleration, a yaw rate sensor that detects angular velocity around a vertical axis, and an azimuth sensor that detects a direction of the vehicle M.

The interior camera 42 is, for example, a digital camera that uses a solid-state image sensor such as a CCD or a CMOS. The interior camera 42 may be a stereo camera. The interior camera 42 is mounted in any interior portion of the vehicle M. The interior camera 42 images a region including a driver seat inside the vehicle. That is, the interior camera 42 images an occupant sitting on the driver seat. The interior camera 42 repeatedly images the region periodically.

The steering sensor 44 is provided at a predetermined position of a steering wheel. For example, a plurality of steering sensors are provided in the steering wheel. The predetermined position is, for example a portion such as a rim portion which is operated (gripped or touched) by a driver. The steering sensor 44 is, for example a sensor that detects a change in electrostatic capacitance.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the vehicle M based on signals received from GNSS satellites. The position of the vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map is output to the MPU 60. The navigation device 50 may perform route guidance using the navigation HMI 52 based on the route on the map. The navigation device 50 may be realized by, for example, a function of a terminal device such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The driving operator 80 includes, for example, an accelerator pedal, a brake pedal, a shift lever, a steering wheel, a heteromorphic steering wheel, a joystick, a turn signal lever, a microphone, and various switches. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120, a second controller 160, an occupant monitor 170, an output controller 180, and a storage 190. Each of the first controller 120, the second controller 160, and the occupant monitor 170 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device such as an HDD of the storage 190 or a flash memory or may be stored in a detachably mounted storage medium such as a DVD, a CD-ROM, or the like so that the storage medium is mounted on a drive device to be installed on the HDD or the flash memory of the automated driving control device 100. The storage 190 stores information table 192. The details of the information table 192 will be described later.

The occupant monitor 170 determines whether an occupant (an occupant sitting on the driver seat) monitors the surroundings of the vehicle. The occupant monitor 170 analyzes an image captured by the interior camera 42 and derives a direction of the face or the direction of a visual line of a driver based on an analysis result. For example, the occupant monitor 170 determines that the occupant monitors the surroundings when the occupant monitor 170 determines that the derived direction of the face or the derived direction of the visual line is within a standard range.

The occupant monitor 170 monitors a state of an occupant (an occupant sitting on the driver seat). The occupant monitor 170 analyzes an image captured by the interior camera 42 and derives alertness, a posture, or the like of the driver based on an analysis result. For example, the occupant monitor 170 derives an alertness index indicating the degree of alertness of the driver based on the derived state.

The occupant monitor 170 determines whether the driver operates or grasp the steering wheel. The occupant monitor 170 determines whether the driver is touching the steering wheel with his or her hands. The occupant monitor 170 acquires a detection result detected by the steering sensor 44 and determines whether the steering sensor 44 is operated based on the acquired detection result. For example, the occupant monitor 170 compares a detection value of the steering sensor 44 acquired at a first time with a detection value of the steering sensor 44 acquired at a second time and determines that the driver operates the steering wheel when the detection value is changed by a threshold or more. When the acquired detection value of the steering sensor 44 is within a predetermined range, the occupant monitor 170 may determine that the driver operates the steering wheel. The occupant monitor 170 may add an analysis result of the image captured by the interior camera 42 and determine whether the driver operates the steering wheel.

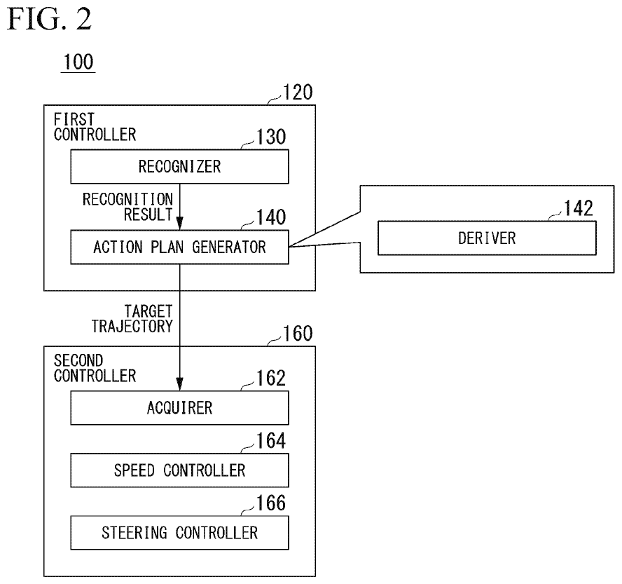

FIG. 2 is a diagram showing a functional configuration of the first controller 120 and the second controller 160. The first controller 120 includes, for example, a recognizer 130 and an action plan generator 140. The recognizer 130 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as a position, a speed, acceleration, or the like of an object near the vehicle M based on information input from the camera 10, the radar device 12, and the finder 14 via the object recognition device 16. The object includes another vehicle. For example, the position of the object is recognized as a position on the absolute coordinates in which a representative point (a center of gravity, a center of a driving shaft, or the like) of the vehicle M is the origin and is used for control. The position of the object may be represented as a representative point such as a center of gravity, a corner, or the like of the object or may be represented as expressed regions. A “state” of an object may include acceleration or jerk of the object or an “action state” (for example, whether a vehicle is changing a lane or is attempting to change the lane).

The recognizer 130 recognizes, for example, a lane in which the vehicle M is traveling (a traveling lane). For example, the recognizer 130 recognizes the traveling lane by comparing patterns of road mark lines (for example, arrangement of continuous lines and broken lines) obtained from the second map information 62 with patterns of road mark lines around the vehicle M recognized from images captured by the camera 10. The recognizer 130 may recognize a traveling lane by recognizing runway boundaries (road boundaries) including road mark lines or shoulders, curbstones, median strips, and guardrails without being limited to road mark lines. In this recognition, the position of the vehicle M acquired from the navigation device 50 or a process result by INS may be added. The recognizer 130 recognizes temporary stop lines, obstacles, red signals, toll gates, and other road events.

The recognizer 130 recognizes a position or a posture of the vehicle M in the traveling lane when the recognizer 130 recognizes the traveling lane. For example, the recognizer 130 may recognize a deviation from the middle of a lane of the representative point of the vehicle M and an angle formed with a line extending along the middle of a lane in the traveling direction of the vehicle M as a relative position and posture of the vehicle M to the traveling lane. Instead of this, the recognizer 130 may recognize a position or the like of the representative point of the vehicle M with respect to any side end portion (a road mark line or a road boundary) of a traveling lane as the relative position of the vehicle M to the traveling lane.

The action plan generator 140 generates a target trajectory along which the vehicle M travels in future automatedly (irrespective of an operation or the like by a driver) so that the vehicle M is traveling along a recommended lane determined by the recommended lane determiner 61 and can handle a surrounding situation of the vehicle M in principle. The target trajectory includes, for example, a speed component. For example, the target trajectory is expressed by arranging spots (trajectory points) at which the vehicle M will arrive in sequence. The trajectory point is a spot at which the vehicle M will arrive for each predetermined traveling distance (for example, about several [m]) in a distance along a road. Apart from the trajectory points, target acceleration and a target speed are generated as parts of the target trajectory for each of predetermined sampling times (for example, about every fractions of a second). The trajectory point may be a position at which the vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are a constant speed traveling event, a following traveling event in which a vehicle follows a front vehicle m at a predetermined vehicle speed (for example, 60 [km]) or less, a lane changing event, a branching event, a joining event, a takeover event, and the like. The action plan generator 140 generates the target trajectory in accordance with an activated event.

The action plan generator 140 controls the vehicle, for example, in one driving state among a driving state A, a driving state B, and a driving state C. The driving state A, the driving state B, and the driving state C are driving states in which a rate of automation (the degree of automation) in control of a vehicle is higher in this order. A high rate of automation (or the degree of automation) means that a rate (or the degree) of control of a vehicle based on a rate of an operation (or the degree of operation) on the vehicle by an occupant is low. The rate of automation (for example, the degree of automation) is linked to a duty to monitor the surroundings of the vehicle requested to a driver. Thus, the rate of automation (for example, the degree of automation) can be paraphrased into the degree of duty to monitor the surroundings of the vehicle requested to the driver. A high rate of automation (for example, the degree of automation) means that a duty to monitor the surroundings of a vehicle requested to a driver is low. A low rate of automation (for example, the degree of automation) means that a duty to monitor the surroundings of the vehicle requested to the driver is high. Hereinafter, examples of the driving states A to C will be described.

For example, the driving state A is a driving state in which a vehicle can control a speed and steering automatedly when an occupant is not operating the steering wheel (not grasping, holding, or touching the steering wheel) and the occupant is not monitoring the surroundings of the vehicle. The driving state B is a driving state is a driving state in which the vehicle can control a speed and steering automatedly when the occupant is monitoring the surroundings of the vehicle (or the degree of monitoring is lower than the degree of monitoring of the driving state A) and the occupant is not operating the steering wheel.

The driving state C is, for example, a driving state in which a monitoring task related to safety driving of the surroundings (front gazing) is imposed on at least a driver. The driving state C is, for example, a driving state in which the vehicle can control a speed and steering automatedly when the occupant is operating the steering wheel and the occupant is monitoring the surroundings of the vehicle.

The driving state C may be a state in which the driver is manually driving. The driving state C may be a state in which an advanced driver assistance system (ADAS) is operating. The ADAS is a driving support system typified by an adaptive cruise control system (ACC) or a lane keeping assist system (LKAS). Some or all of the driving states A to C may be driving states in which a speed or steering of a vehicle can be controlled automatedly.

In the driving states A to C, for example, following travel of following the front vehicle m traveling in front of the vehicle M may be performed. The following travel is control in which the vehicle M keeps an inter-vehicle distance between the vehicle M and the front vehicle m as a predetermined distance (for example, a predetermined distance according to a speed) and follows the front vehicle m. When the front vehicle m which is a following target is no longer present in the driving state in which the following travel is performed, the following control is cancelled. In this case, a process of transitioning to a driving state in which the rate of automation (or the degree of automation) is lower than in the driving state in which the following control is performed. For example, as the process of transitioning to the driving state in which the rate of automation (or the degree of automation) is lower, the HMI 30 gives a notification for requesting the driver to monitor the surroundings, a notification for requesting the driver to grasp the steering wheel, or the like. The case in which the front vehicle m which is the following target is not located means that the front vehicle m moves in a different direction or to a different lane from the traveling direction of the vehicle M.

The conditions that the driving states A, B, and C are controlled is exemplary and the rates of automation (or the degree of automation) of the vehicle may be arbitrarily set higher in the order of the driving states A, B, and C. For example, some or all of the driving states A, B, and C may be automated driving states. Some or all of the driving states A, B and C may be states in which driving support is performed rather than the automated driving states. Instead of the three driving states, the present embodiment may be applied to two or more driving states. Of the driving states A to C, one driving state is an example of a “first control state” and a driving state in which the degree of automation is lower than the driving state considered to be the first control state is an example of a “second control state.”

The action plan generator 140 includes, for example, a deriver 142. The details of a process by the deriver 142 will be described later.

The second controller 160 controls the travel driving power output device 200, the brake device 210, and the steering device 220 so that the vehicle M passes along the target trajectory generated by the action plan generator 140 at a scheduled time. A combination of the action plan generator 140 and the second controller 160 is an example of a “driving controller.”

The second controller 160 includes, for example, an acquirer 162, a speed controller 164, and a steering controller 166. The acquirer 162 acquires information regarding a target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the vehicle M and the feedback control based on separation from the target trajectory in combination.

Referring back to FIG. 1, for example, the output controller 180 causes the HMI 30 to give a predetermined notification. The predetermined notification is a notification for requesting an occupant to grasp the steering wheel or a notification for requesting an occupant to monitor the surroundings.

The travel driving power output device 200 outputs a travel driving power (torque) for traveling the vehicle to a driving wheel. The travel driving power output device 200 includes, for example, a combination of an internal combustion engine, an electric motor, and a transmission and an ECU controlling them. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Process Related to Continuation of Driving State A]

The automated driving control device 100 switches a driving state to a control state B (a second control state) in which the rate of automation (or the degree of automation) is lower than in the driving state A when a continuous traveling time of the driving state A (the first control state) which can be executed without imposing a task related to monitoring of the surroundings of the vehicle M (a duty to monitor the surroundings) or a task related to the steering wheel of the vehicle M (grasping or operating the steering wheel, touching the steering wheel, or the like) on an occupant (a driver) of the vehicle M has passed a set time (a predetermined time).

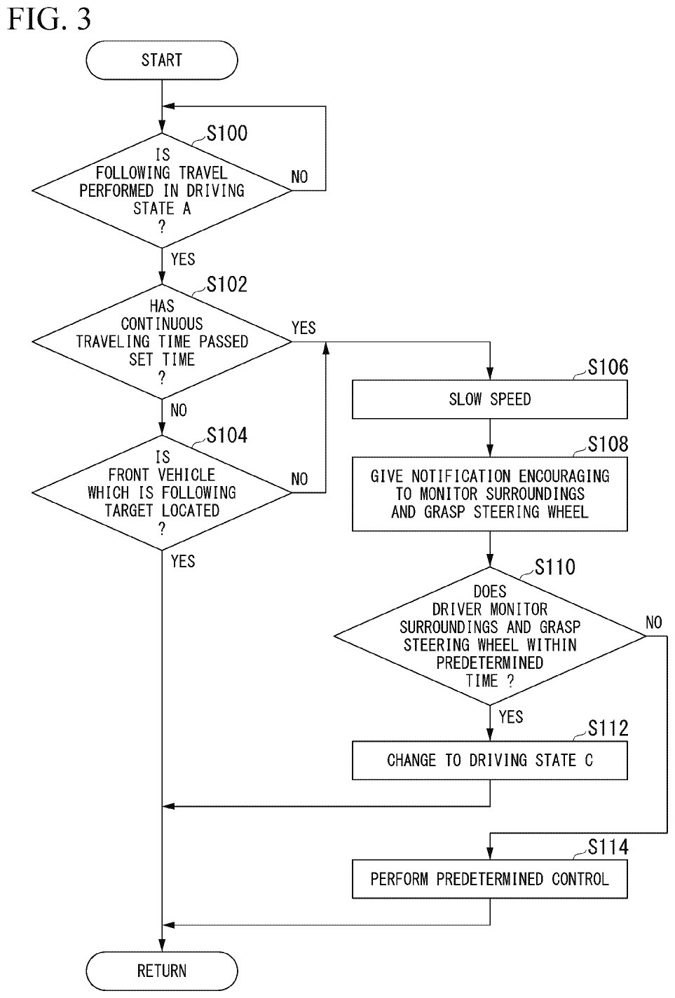

FIG. 3 is a flowchart showing an example of a flow of a process performed by the automated driving control device 100. First, the action plan generator 140 determines whether the vehicle is performing the following travel in the driving state A (step S100). When the following travel is performed in the driving state A, the action plan generator 140 determines whether the continuous traveling time for which the following travel is performed in the driving state A has passed the set time (step S102). The continuous traveling time may be a time for which the vehicle is traveling without stopping. Even when stopping for several tens of seconds or several minutes is included, the stopping may be considered to be the continuous traveling time. A scheme of determining the “set time” will be described later.

When the continuous traveling time for which the following travel is performed in the driving state A has not passed the set time, the action plan generator 140 determines whether there is a front vehicle which is the following target (step S104). When there is a front vehicle which is the following target, the process of one routine of the flowchart ends.

When the continuous traveling time for which the following travel is performed in the driving state A in the process of step S102 has passed the set time or when it is determined in the process of step S104 that there is no front vehicle which is the following target, the process proceeds to step S106. That is, the action plan generator 140 slows the speed of the vehicle M (step S106). When the front vehicle which is the following target changes its lane or the front vehicle enters a route different from the route that the vehicle M has traveled, it is determined that there is no front vehicle which is the following target. Instead of slowing the speed in the process of step S106, acceleration or an increase in the speed may be inhibited.

Subsequently, the output controller 180 causes the HMI 30 to output a specific notification for prompting the driver to monitor the surroundings of the vehicle M and (or) grasp (operate) the steering wheel (step S108). The process of step S106 may be performed after the process of step S108. Subsequently, the occupant monitor 170 determines whether the driver monitors the surroundings of the vehicle M and grasps the steering wheel within a predetermined time from the specific notification of step S108 (step S110).

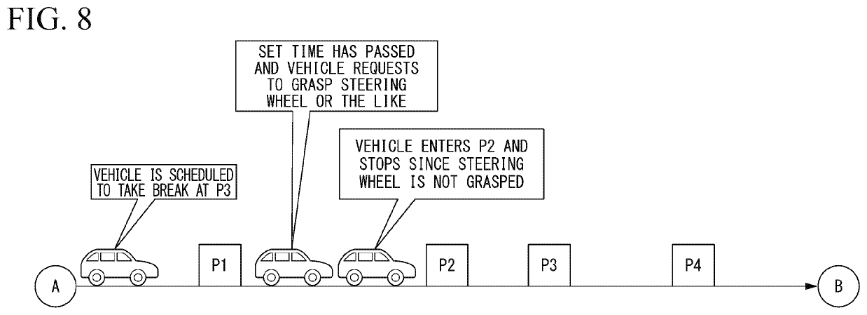

When the driver monitors the surroundings of the vehicle M and grasps the steering wheel within the predetermined time, the action plan generator 140 changes the driving state from the driving state A to the driving state C (step S112). When the driver does not monitor the surroundings of the vehicle M or does not grasp the steering wheel within the predetermined time, the action plan generator 140 performs predetermined control (step S114). The predetermined control is, for example, control in which the vehicle M stops in a shoulder (of the road) or another predetermined position, control in which the vehicle M enters a closest parking zone, or the like. The details of the process will be described below with reference to FIG. 8. The control in a case in which the driver does not perform an imposed task (that is, the predetermined control) may be, for example, control in which driving is not alternated and the own vehicle M performs emergency stopping. Then, the process of one routine of the flowchart ends.

In the process of the foregoing flowchart, the driving state A or the driving state C has been described as the control state in which the following travel is performed. Instead of this, the driving state A or the driving state C may be implemented even when the following travel is not performed. In this case, in step S100 of FIG. 3, it is determined whether the driving state A is implemented and the process of step S104 is omitted.

In the process of the foregoing flowchart, the driving state A has been described as the control that can be executed without imposing the task related to the monitoring of the surroundings or the task related to the steering wheel. However, instead of this, the driving state A may be control in which one of the two tasks is imposed. In this case, in step S108, a notification for prompting the driver to perform a task different from the task imposed in the driving state A is given. In step S110, it is determined whether the task different from the task imposed in the driving state A is performed.

In the process of the foregoing flowchart, the process in the case of the change from the driving state A to the driving state C has been described. Instead of this, the process of the foregoing flowchart may be applied to a process when the driving state is changed from a driving state in which the degree of automated driving is high to a driving state in which the degree of automated driving is low. The process of the foregoing flowchart may be applied to a process in which the selected driving state is changed to a driving state different from the selected driving state. In the foregoing example, when the continuous traveling time has passed the set time, the control state is switched to the predetermined driving state, as described above. Instead of this, the control state may be switched to the predetermined driving state when the vehicle M travels more than a predetermined distance in the selected traveling state. For example, one or both of the continuous traveling time passing the set time and the vehicle M traveling more than the predetermined distance is equivalent to the degree of traveling continuation (the continuous traveling time or the continuous traveling distance) exceeding the degree of standard (for example, a standard value or a threshold). The degree of traveling continuation easily exceeding the degree of standard means that the set time is set to be shorter when the continuous traveling time is adopted, and the predetermined distance is set to be shorter than a distance that the vehicle M travels. In the following description, an example in which the continuous traveling time and the set time are used will be described. When the predetermined distance and the distance that the vehicle M travels are used, the predetermined distance and the distance that the vehicle M travels may be applied like the case in which the continuous traveling time and the set time are used or the case in which the set time is set.

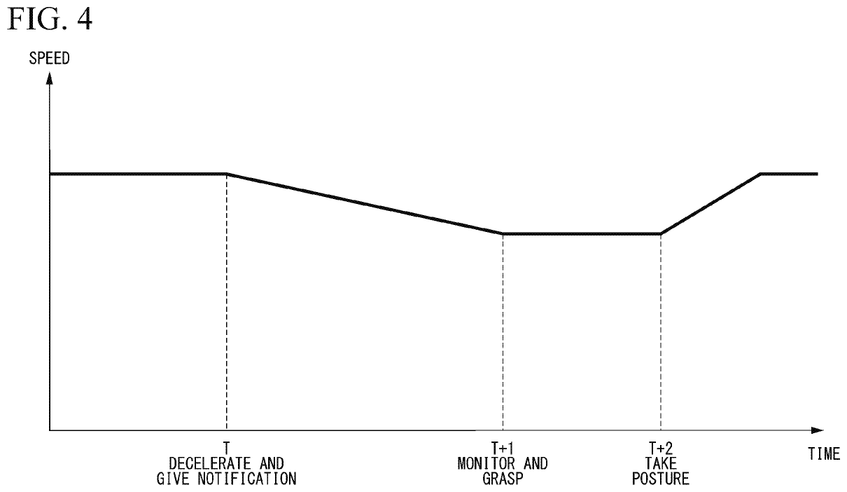

FIG. 4 is a diagram showing an example of a change in a speed of the vehicle after step S106. At time T, a specific notification is given at a timing before or after the speed of the vehicle M decelerates. The degree of deceleration is the degree of determination based on a surrounding situation of the vehicle M. For example, when there is no vehicle traveling behind the vehicle M within a predetermined distance from the vehicle M, the vehicle M decelerates to the degree of first deceleration. When there is a vehicle traveling behind the vehicle M within a predetermined distance from the vehicle M, the vehicle M decelerates to the degree of second deceleration in which the degree of deceleration is less than the degree of first deceleration. A lower limit of the speed of the vehicle may be determined based on a speed of the vehicle M before the deceleration. Thus, the control of the vehicle M appropriate for the vehicle traveling behind it is realized.

At time T+1, when the driver monitors the surroundings of the vehicle M and grasps the steering wheel, the vehicle M stops decelerating or inhibits the degree of deceleration. At time T+2, when the driver assumes an appropriate posture, the vehicle M accelerates to a predetermined speed. For example, the occupant monitor 170 analyzes an image captured by the interior camera 42 and determines whether the driver assumes the appropriate posture based on an analysis result. For example, the occupant monitor 170 determines that the driver assumes the appropriate posture when the degree of matching between the analysis result (for example, a distribution of a feature amount) of the image and matching data stored in advance in the storage device of the vehicle M is equal to or greater than a threshold.

In this way, when the driving state A is switched to the driving state C, the vehicle M controls a speed of the vehicle such that the driver can transition to a state in which the driving state C can be applied. Thus, convenience for the driver is improved.

### [Deriving Set Time]

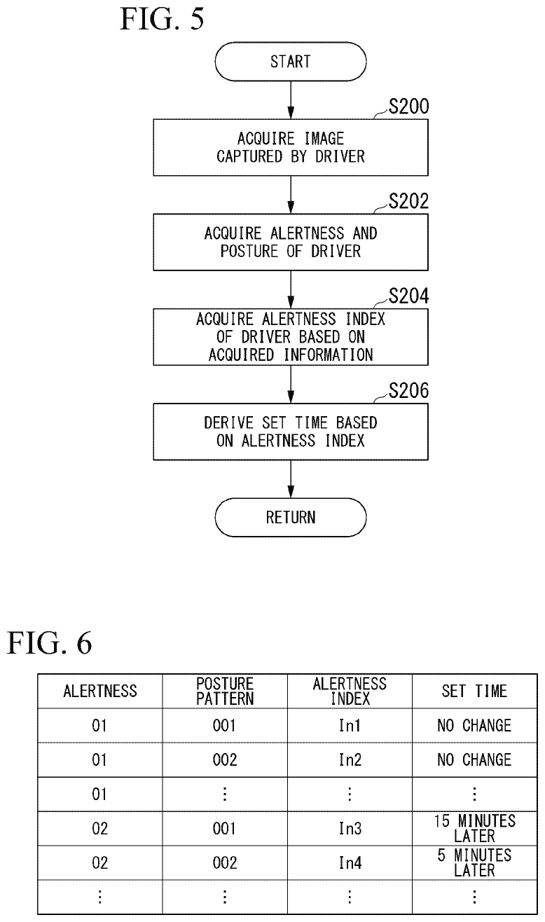

FIG. 5 is a flowchart showing an example of a flow of a process performed by the deriver 142 and the occupant monitor 170. The details of the process will be described with reference to FIG. 6. First, the occupant monitor 170 acquires an image captured by the interior camera 42 (step S200). Subsequently, the occupant monitor 170 acquires alertness and a posture of the driver (a state of the driver) based on the image captured in step S200 (step S202). Subsequently, the occupant monitor 170 acquires an alertness index of the driver based on the alertness and the posture acquired in step S202 (step S204).

Subsequently, the deriver 142 derives the set time based on the alertness index acquired in step S204 (step S206). The deriver 142 derives the set time so that the set time is shorter as the alertness index is lower. A low alertness index means that the driver is in a low awareness state (for example, the driver is drowsy). The low awareness state of the driver is, for example, an awareness state in which the driver is likely to be unable to perform a task imposed in the low driving state when the driving state in which the degree of automated driving is lower than in the executed driving state is executed. Then, the process of the flowchart ends.

FIG. 6 is a diagram showing an example of content of the information table 192. The information table 192 is, for example, information in which alertness, a posture pattern, the alertness index, and the set time (the predetermined distance when the predetermined distance is used) are associated with each other. Of these items, information regarding the alertness or the posture pattern may be omitted. In this case, in the process of the flowchart of FIG. 5 described above, the omitted information may not be acquired.

For example, the alertness is derived based on a state of the eyelids or the degree of openness of the eyes of the driver in an image captured by the occupant monitor 170. For example, when the eyelids tend to droop further in the vertical direction than in the state of the eyelids in a case in which the previously acquired alertness is high, the degree of openness of the eyes tends to be closed further than the degree of openness of the eyes in the case in which the previously acquired alertness is high, or the degree of nictitation (for example, a time for which the eyes are closed in nictitation) tends to be greater than the case in which the previously acquired alertness is high, the derived alertness index associated with the alertness tends to be low.

For example, the posture pattern of the driver is derived using an image captured by the occupant monitor 170 in accordance with a scheme such as pattern matching. For example, as the degree of displacement of the posture of the driver with respect to a standard posture is higher, the alertness index associated with the posture pattern is set to be low. For example, as the face or body of the driver tends to be inclined in the vertical direction more than an inclination (a standard posture) of the face or body in a case in which the previously acquired alertness is high or the face or body of the driver tends to droop in the direction of the back seat more than in a state of the face or body (a standard posture) in the case in which the previously acquired alertness is high, a tendency for the alertness index associated with the posture pattern to be low is derived. When the face or body of the driver is a preset posture pattern, a tendency for the alertness index associated with a posture pattern to be low may be derived. The preset posture pattern is a posture pattern which a person assumes when she or he is drowsy and is, for example, yawning or stretching her or his body.

The occupant monitor 170 acquires the alertness index associated with the derived alertness and the posture pattern with reference to the information table 192. Then, the deriver 142 derives the set time with reference to the information table 192. The occupant monitor 170 may input an image captured in a learned model and derive the alertness, the posture pattern, or the alertness index based on a result output by the learned model. The learned model is a model that is learned so that alertness, a posture pattern, and an alertness index indicating a label assigned to an image are derived when the image is input.

As described above, the deriver 142 can derive the set time in accordance with the state of the driver. Thus, the automated driving control device 100 can appropriately continue the automated driving.

[Control after Transition to Driving State C]

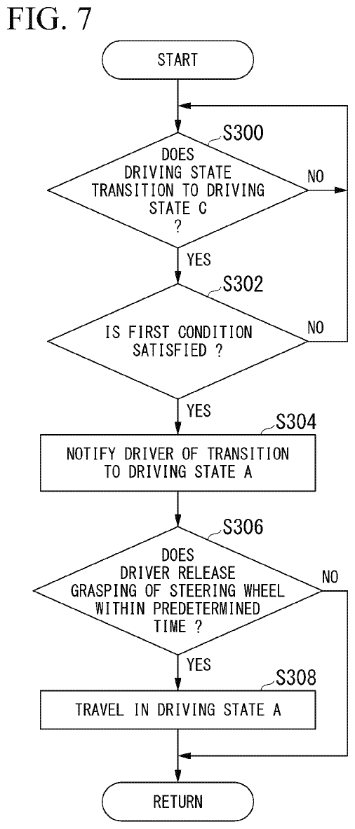

FIG. 7 is a flowchart showing an example of a flow of a process performed by the automated driving control device 100 after transition to the driving state C. First, the action plan generator 140 determines whether the driving state transitions to the driving state C (step S300). When the driving state transitions to the driving state C, the automated driving control device 100 determines whether a first condition is satisfied (step S302). The first condition is that the driving state C continues for a specified time or an alertness index of the driver derived by the occupant monitor 170 is equal to or greater than a threshold. When the first condition is not satisfied, the process returns to step S300.

When the first condition is satisfied, the output controller 180 controls the HMI 30 such that the driver is notified of transition to the driving state A (step S304). Subsequently, the occupant monitor 170 determines whether the driver releases her or his grasp of the steering wheel within a predetermined time from the notification of step S304 (step S306). When the driver does not release her or his grasp of the steering wheel within the predetermined time, the process of one routine of the flowchart ends. This is because when the driver does not release her or his grasp on the steering wheel, the driver is predicted to have an intention to desire to operate the steering wheel by herself or himself.

When the driver releases her or his grasp of the steering wheel within the predetermined time, the action plan generator 140 controls the vehicle M such that the travel M travels in the driving state A (step S308). Then, the process of the flowchart ends.

In this way, when the first condition is satisfied after the transition to the driving state C of the vehicle M, the driving state transitions to the driving state in which the degree of automated driving is higher than in the driving state C. Thus, the convenience for the driver is improved.

### [Predetermined Control]

An example of the “predetermined control” of step S114 of the flowchart of FIG. 3 described above will be described. FIG. 8 is a diagram showing an example of the predetermined control. For example, it is assumed that the vehicle M is scheduled to start at a starting point A and stops at a parking point P3 on the way to a destination point B. The parking point P3 is a parking point located ahead of parking points P1 and P2. Since a following travel time has passed the set time after the vehicle M passes through the parking point P1, the driver is requested to monitor the surroundings of the vehicle M and hold the steering wheel within a predetermined time. At this time, it is assumed that the driver does not grasp the steering wheel within the predetermined time. In this case, the vehicle M performs the following control as the predetermined control. For example, the vehicle M stops the following travel before the parking point P2 closest from the current point and enters the parking point P2 with the driving state A maintained. Then, after the vehicle enters the parking point P2 or stops at a predetermined position of the parking point P2, the vehicle M transitions to the driving state B, the driving state C, or manual driving.

In this way, the vehicle M is appropriately controlled even when the driving state of the vehicle M transitions from the driving state A to the driving state C.

In the foregoing embodiment, when the predetermined driving state (the first control state) is continuously executed for the first time, the output controller 180 may give a notification encouraging the driver of the vehicle M to take a break. When the driving state (the second control state) in which the degree of automated driving is lower than in the predetermined driving state is continuously executed for a second time that is shorter than the first time, the output controller 180 may give a notification encouraging the driver of the vehicle M to take a break. When the vehicle M travels a first distance in the predetermined driving state (the first control state), the output controller 180 may give a notification encouraging the driver of the vehicle M to take a break. When the vehicle M travels a second distance that is shorter than the first distance in the driving state (the second control state) in which the degree of automated driving is lower than in the predetermined driving state, the output controller 180 may give a notification encouraging the driver of the vehicle M to take a break. Thus, the alertness of the driver is inhibited from being equal to or less than a predetermined degree.

According to the above-described first embodiment, when the continuous traveling time of the driving state A has passed the set time, the automated driving control device 100 can perform the automated driving in the driving state appropriate for an execution situation of the automated driving by switching the driving state to the driving state B in which the rate of automation (or the degree of automation) is lower than in the driving state A.

For example, when the driving state A continues, the task related to the monitoring of the surroundings or the task related to the grasping or the like of the steering wheel is not imposed on the driver. However, the driver is requested to monitor the surroundings, grasp the steering wheel, or the like in some cases in order to transition to the driving state in which the degree of automated driving decreases in accordance with a change in a surrounding situation. To prepare for such a situation, it is preferable to set the alertness of the driver to be equal to or greater than a predetermined degree. However, as described above, since no task is imposed in the driving state A, there is a possibility of the alertness of the driver decreasing. Therefore, according to the embodiment, when the continuous traveling time of the driving state A has passed the set time, the driving state is switched to the driving state B so that the alertness of the driver does not decrease, and thus a process contributing to maintaining of the alertness of the driver is performed. That is, the automated driving control device 100 can perform the automated driving in the driving state appropriate for an execution situation of the automated driving.

### Second Embodiment

Hereinafter, a second embodiment will be described. In the second embodiment, another example in which the automated driving control device 100 changes a set time (a predetermined distance when the predetermined distance is used) based on a state (a posture) of an occupant will be described. Hereinafter, differences from the first embodiment will be described.

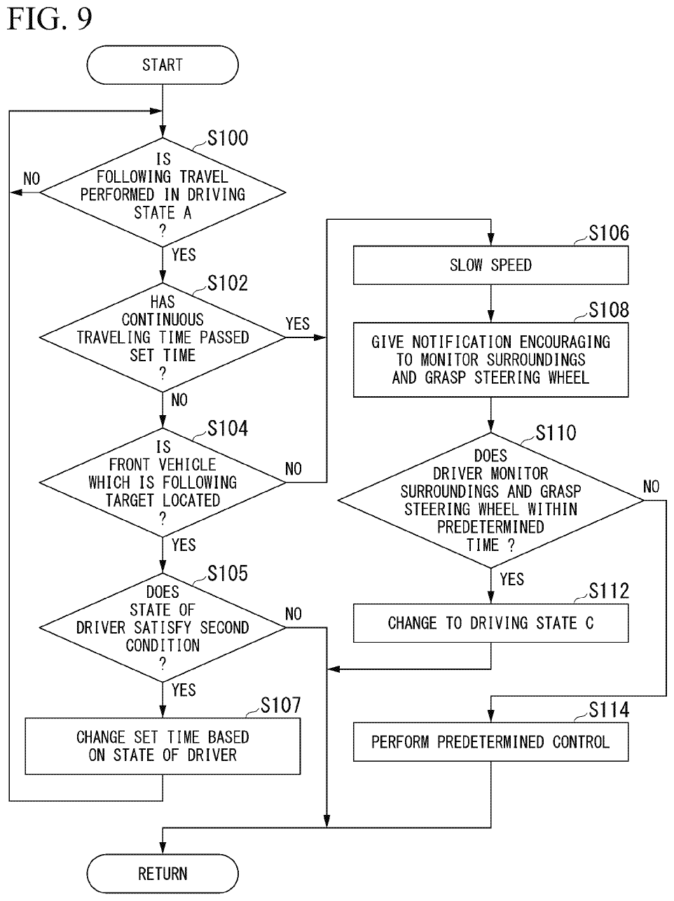

FIG. 9 is a flowchart showing an example of a flow of a process performed by the automated driving control device 100 according to the second embodiment. Differences from the process of the flowchart of FIG. 3 described in the first embodiment will be mainly described.

When it is determined in step S104 that there is a front vehicle which is the following target, the occupant monitor 170 determines whether the state of the driver satisfies the second condition (to be described below) (step S105). When the state of the driver does not satisfy the second condition, the process of the flowchart ends.

When the state of the driver satisfies the second condition (that is, when the posture is displaced with respect to the standard posture), the deriver 142 changes the set time of step S102 based on the state of the driver (step S107). Then, the process returns to step S100, a subsequent process is performed, and the set time changed in the process of step S107 described above is set in step S102.

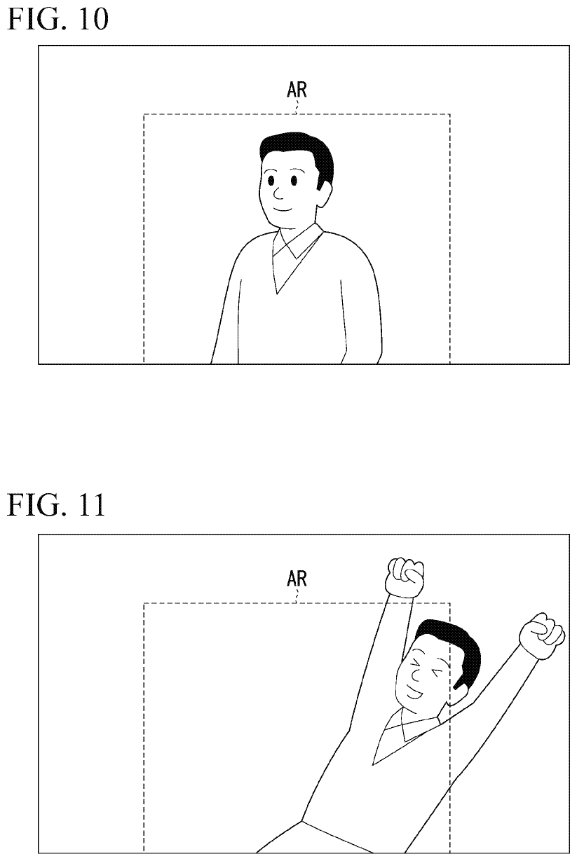

Here, the “second condition” will be described. The second condition is, for example, a condition that the state of the driver is different from that at normal times or a state in which the alertness of the driver is predicted to be low. FIG. 10 is a diagram showing an example of a state of a driver which does not satisfy the second condition. For example, when the body of the driver enters a specific region AR set in a captured image, the occupant monitor 170 determines that the state of the driver does not satisfy the second condition.

FIG. 11 is a diagram showing an example of a state of the driver which satisfies the second condition. For example, when the body of the driver falls outside of the specific region AR set in a captured image or when the degree to which it falls outside of the specific region is equal to or greater than a threshold, the occupant monitor 170 determines that the state of the driver satisfies the second condition. For example, the occupant monitor 170 analyzes the captured image during the driving state A and derives the number of times the body of the driver falls outside of the specific region AR. When the number of times the body of the driver falls outside of the specific region AR is equal to or greater than a threshold, the occupant monitor 170 determines that the state of the driver satisfies the second condition. When the alertness of the driver is lowered, the drivers stretches or inclines her or his body horizontally in some cases. In these cases, part of the body of the driver protrudes from the specific region AR.

According to the above-described second embodiment, when the state of the driver satisfies the second condition, the deriver 142 changes the set time related to the continuation of the driving state A based on the state of the driver. Thus, the same advantages as the advantages of the first embodiment are obtained.

### Third Embodiment

Hereinafter, a third embodiment will be described. In the third embodiment, the automated driving control device 100 changes a set time (a predetermined distance when the predetermined distance is used) based on a remaining time (a movement state of the vehicle) until the vehicle M arrives at a set point. Hereinafter, differences from the first embodiment will be described.

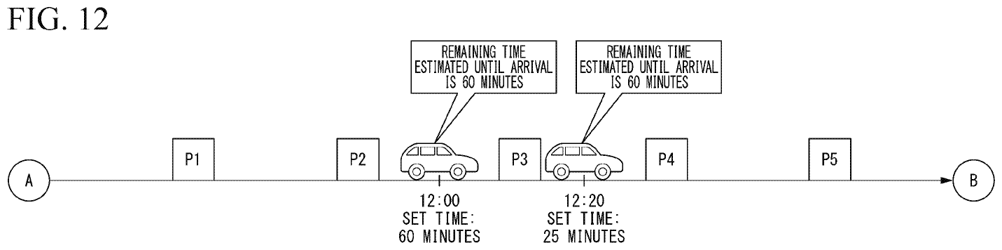

FIG. 12 is a diagram showing a process in which a set time is changed based on a remaining time. It is assumed that the vehicle M is traveling toward a destination B. At time 12:00 at which the vehicle M is traveling between the parking points P2 and P3, a remaining time until the vehicle M arrives at the destination B is predicted to be 60 minutes. The predicted remaining time is, for example, a remaining time predicted based on information acquired from the navigation device 50 or another server device. At this time, the deriver 142 determines that the alertness of the driver is not lowered since the remaining time until the destination is 60 minutes and determines that the driving state A continues for 60 minutes. That is, the deriver 142 sets 60 minutes as the set time.

It is assumed that the remaining time until the vehicle M arrives at the destination B is predicted to be 60 minutes similarly to the above description since the vehicle M is delayed more than expected at time 12:20 at which the vehicle M is traveling between parking points P3 and P4. In this case, the deriver 142 changes the set time to a shorter time such as 25 minutes, as shown in FIG. 12. This is because the remaining time from the point between the parking points P3 and P4 to the destination is 60 minutes and the driving state A does not continue until arrival at the destination, for example, the driving state A does not continue for more than 60 minutes.

According to the above-described third embodiment, the automated driving control device 100 sets the time for which the driving state A continues based on the remaining time until the vehicle arrives at the destination. Thus, the same advantages as the advantages of the first embodiment are obtained.

### Fourth Embodiment

Hereinafter, a fourth embodiment will be described. In the fourth embodiment, the automated driving control device 100 changes a set time (a predetermined distance when the predetermined distance is used) based on a speed of the vehicle M. Hereinafter, differences from the first embodiment will be described.

For example, the deriver 142 sets the set time to be shorter as an average speed in a predetermined section is larger. For example, when an average speed of the vehicle is 80 km/hour, the deriver 142 sets a first time as the set time. When the average speed of the vehicle is 60 km/hour, the deriver 142 sets a second time longer than the first time as the set time. When a speed of the vehicle is fast, the alertness of the driver tends to be lowered.

According to the above-described fourth embodiment, the automated driving control device 100 sets a time for which the driving state A continues based on the speed of the vehicle. Thus, the same advantages as the advantages of the first embodiment are obtained.

### <Other>

The foregoing embodiments may be performed in an integrated manner. For example, in the foregoing first to fourth embodiments, the set time (or the predetermined distance) may be changed based on the set time (the predetermined distance when the predetermined distance is used) derived by the deriver 142. In this case, for example, the deriver 142 may change the set time based on a result obtained by statistically processing the set time derived in accordance with each scheme of the first to fourth embodiments. For example, the deriver 142 sets an average time of the set times or an average time obtained by weighting and averaging the set times as the set time.

According to the above-described embodiments, the automated driving control device 100 switches the driving state to the traveling state different from the traveling state selected among the plurality of traveling states when the vehicle M travels for the continuous traveling time or the continuous traveling distance that the vehicle M continuously travels in the selected traveling state over the standard value. Thus, it is possible to perform the automated driving in the driving state appropriate for an execution situation of the automated driving.

### [Hardware Configuration]

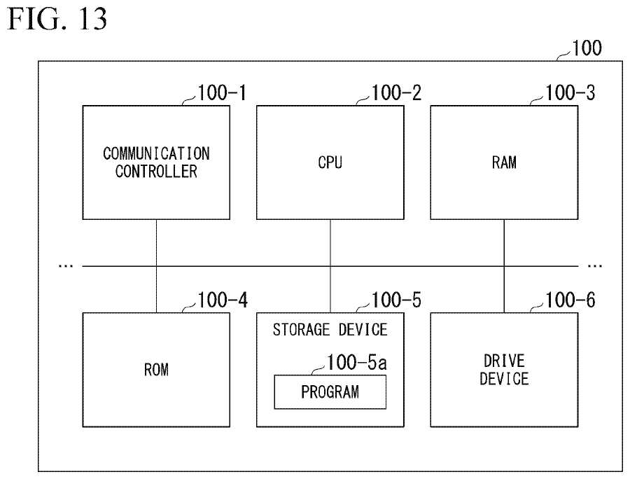

FIG. 13 is a diagram showing an example of a hardware configuration of the automated driving control device 100 according to an embodiment. As shown, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not shown) or the like to be executed by the CPU 100-2. Thus, some or all of the recognizer 130, the action plan generator 140, and the second controller 160 are realized.

The above-described embodiment can be expressed as follows: a vehicle control device including a storage device that stores a program and a hardware processor, the hardware processor executing the program stored in the storage device to perform: recognizing a surrounding situation of a vehicle; controlling a speed or steering of the vehicle based on a recognition result; selecting one of a plurality of traveling states in which rates of automation related to control of the vehicle are different from each other; and switching the selected traveling state to the traveling state different from the traveling state selected among the plurality of traveling states when a continuous traveling time or a continuous traveling distance that the vehicle continuously travels in the selected traveling state exceeds a standard value.

The embodiments for carrying out the present invention have been described above, but the present invention is not limited to the embodiments. Various modifications and substitutions can be made within the scope of the present invention without departing from the gist of the present invention.

What is claimed is:

1. A vehicle control device comprising:
a recognizer configured to recognize a surrounding situation of a vehicle; and
a driving controller configured to control a speed or steering of the vehicle based on a recognition result of the recognizer,
wherein the driving controller selects one of a plurality of traveling states in which rates of automation related to control of the vehicle are different from each other, and
wherein the driving controller switches the selected traveling state to the traveling state different from the traveling state selected among the plurality of traveling states when a continuous traveling time or a continuous traveling distance that the vehicle continuously travels in the selected traveling state exceeds a standard value.

2. The vehicle control device according to claim 1, wherein the plurality of traveling states are a first traveling state and a second traveling state in which the rate of automation is lower than in the first traveling state.

3. The vehicle control device according to claim 2, wherein, in the first traveling state, one or both of a task related to monitoring of surroundings of the vehicle and a task related to a steering wheel of the vehicle is not imposed on an occupant of the vehicle.

4. The vehicle control device according to claim 2, wherein the driving controller switches the traveling state to the second traveling state when a continuous traveling time of the first traveling state has passed a predetermined time or a continuous traveling distance of the first traveling state has passed a predetermined distance.

5. The vehicle control device according to claim 2, wherein a first control state is a control state executed when the vehicle is performing following travel of following a front vehicle of the vehicle.

6. The vehicle control device according to claim 1, wherein the driving controller sets the standard value so that the continuous traveling time or the continuous traveling distance easily exceeds the standard value based on one or both of information regarding movement of the vehicle and information regarding a state of a driver of the vehicle.

7. The vehicle control device according to claim 6,
wherein the driving controller sets the standard value based on at least the information regarding the state of the driver of the vehicle,
wherein the information regarding the state of the driver is alertness of the driver, and
wherein the standard value is set so that the continuous traveling time or the continuous traveling distance exceeds the standard value more easily as the alertness of the driver is lower.

8. The vehicle control device according to claim 6,
wherein the driving controller sets the standard value based on at least the information regarding the state of the driver of the vehicle,
wherein the information regarding the state of the driver is a posture of the driver, and
wherein the standard value is set so that the continuous traveling time or the continuous traveling distance exceeds the standard value more easily as the degree of displacement of the posture of the driver with respect to a standard posture is higher.

9. The vehicle control device according to claim 1,
wherein the driving controller sets the standard value based on at least information regarding movement of the vehicle,
wherein the information regarding the movement of the vehicle is a remaining time until the vehicle arrives at a destination, and
wherein the standard value is set based on a remaining time until the vehicle arrives at the destination.

10. The vehicle control device according to claim 1,
wherein the driving controller sets the standard value based on at least information regarding movement of the vehicle,
wherein the information regarding the movement of the vehicle is a speed of the vehicle, and
wherein the standard value is set based on the speed of the vehicle.

11. The vehicle control device according to claim 1, wherein the driving controller slows a speed of the vehicle or inhibits an increase in the speed of the vehicle when the selected traveling state is switched to the different traveling state.

12. The vehicle control device according to claim 1, further comprising:
an output controller configured to cause an output device to output one or both of a notification for requesting a driver of the vehicle to monitor surroundings of the vehicle and a notification for requesting the driver of the vehicle to grasp a steering wheel when the driving controller switches the selected traveling state to the different traveling state.

13. The vehicle control device according to claim 1, further comprising:
an output controller configured to
give a notification encouraging the driver of the vehicle to take a break when the selected traveling state is continuously executed for a first time or the vehicle has traveled more than a first distance in the selected traveling state, and
give a notification encouraging the driver of the vehicle to take a break when the different traveling state is continuously executed for a second time shorter than the first time or the vehicle has traveled more than a second distance shorter than the first distance in the different traveling state.

14. The vehicle control device according to claim 1,
wherein the selected control state is a control state executed when the vehicle is performing following travel of following a front vehicle of the vehicle, and
wherein, when the front vehicle is no longer present during the following travel of following the front vehicle of the vehicle, the driving controller switches the selected control state to the different control state even before the continuous traveling time has passed a set time.

15. The vehicle control device according to claim 1,
wherein the selected control state is a control state executed when the vehicle is performing following travel of following a front vehicle of the vehicle, and
wherein the vehicle control device further comprises an output controller configured to cause an output device to output one or both of a notification for requesting a driver of the vehicle to monitor surroundings of the vehicle and a notification for requesting the driver of the vehicle to grasp a steering wheel when the front vehicle is no longer present during the following travel of following the front vehicle of the vehicle.

16. A vehicle control method causing a computer to perform:
recognizing a surrounding situation of a vehicle;
controlling a speed or steering of the vehicle based on a recognition result;
selecting one of a plurality of traveling states in which rates of automation related to control of the vehicle are different from each other; and
switching the selected traveling state to the traveling state different from the traveling state selected among the plurality of traveling states when a continuous traveling time or a continuous traveling distance that the vehicle continuously travels in the selected traveling state exceeds a standard value.

17. A non-transitory computer-readable storage medium that stores a computer program to be executed by a computer to perform at least:
recognizing a surrounding situation of a vehicle;
controlling a speed or steering of the vehicle based on a recognition result;
selecting one of a plurality of traveling states in which rates of automation related to control of the vehicle are different from each other; and
switching the selected traveling state to the traveling state different from the traveling state selected among the plurality of traveling states when a continuous traveling time or a continuous traveling distance that the vehicle continuously travels in the selected traveling state exceeds a standard value.
